(19) United States
(12) Patent Application Publication
(10) Pub. No.: US 2023/0282944 A1
(43) Pub. Date: Sep. 7, 2023

(54) POLYELECTROLYTE COMPLEX NANOPARTICLE MEMBRANE FOR A STABLE LITHIUM-SULFER BATTERY AT LEAN ELECTROLYTE CONDITIONS

(71) Applicant: MONASH UNIVERSITY, Clayton (AU)

(72) Inventors: Petar JOVANOVIC, Clayton (AU); Mahdokht SHAIBANI, Clayton (AU); Mainak MAJUMDER, Clayton (AU)

(73) Assignee: MONASH UNIVERSITY, Clayton (AU)

(21) Appl. No.: 18/006,404

(22) PCT Filed: Jul. 23, 2021
(86) PCT No.: PCT/AU2021/050803

§ 371 Date: Jan. 23, 2023

(30) Foreign Application Priority Data
Jul. 24, 2020 (AU) 2020902586

(51) Int. Cl. H01M 50/497; H01M 50/403; H01M 50/417; B82Y 30/00; B82Y 40/00; H01M 10/052

(52) U.S. Cl. CPC H01M 50/497; H01M 50/403; H01M 50/417; B82Y 30/00; B82Y 40/00; H01M 10/052; H01M 2300/0082; H01M 2300/0094

(57) ABSTRACT

A method of making a polyelectrolyte complex membrane separator for a Lithium-Sulfur battery to support lean electrolyte operation, comprising the steps of: forming polyelectrolyte complex nanoparticles by the addition of polyethylenimine (PEI) to tannic acid (TA); adding bovine serum albumin (BSA); purifying the nanoparticles; re-dispersing the nanoparticles in water to form a nanoparticle suspension; and dipcoating a polyolefin membrane in the nanoparticle suspension.

### FIELD OF THE INVENTION

The present invention relates to Li—S batteries, in particular a membrane separator inserted between the cathode and anode of the cell to allow for high areal capacity at lean electrolyte conditions.

### BACKGROUND TO THE INVENTION

Owing to their high theoretical capacities and specific energy densities, lithium sulfur (Li—S) batteries have attracted significant attention as potential second-generation energy storage devices. In a bid to overtake lithium-ion battery (LIB) performance, cathodes with practical areal loadings of sulfur have been increasingly investigated in recent years, with cathode designs, architectures and novel materials that have allowed desired areal capacities to rival or even outperform LIBs. This has demonstrated that areal capacities of Li—S batteries can greatly exceed those of LIBs. However, such cell designs have a number of issues in common. The high sulfur loading is overshadowed by the generally poor sulfur utilization, low percentage of sulfur content in the cathode, low cyclability, frequent necessity of 3D hosts such as porous carbon paper and metal foam, while employing high electrolyte to sulfur (E/S) ratios. Despite the high areal capacity of these cells, they are not able to yield sufficient energy densities. With more and more research groups moving towards translating the high capacity coin cells to high specific energy pouch cells, it is rapidly becoming imperative to minimize the electrolyte volume as far as practicable, and it is time to focus on cycling such cells under ‘lean electrolyte’ conditions.

It is accepted that a Li—S battery separator must have advanced functions, which cannot be fulfilled by the usual polyolefin (polyethylene or polypropylene) separators routinely used in lithium-ion battery technologies. The gap in literature is that very few separators are able to achieve a holistic improvement in performance, and the role of the separator in attaining a competitive energy density has been overlooked.

The high E/S ratios reported in literature, which are often at levels considered to be ‘flooded systems’, often overinflate Li—S battery performance. Lean electrolyte conditions have not received enough attention because when the E/S ratio is decreased to practical levels, a number of issues are exacerbated. It leads to increased viscosity of the electrolyte which causes aggravated polarization, spatially uneven electrochemical reactions, retarded kinetics and parasitic consumption of electrolyte at the anode due to the continual rupture and re-formation of the Solid Electrolyte Interphase. The continuous electrolyte consumption creates a feedback loop that rapidly increases internal cell resistances, decreases capacities and Coulombic efficiencies, and due to the ultimate drying up of the cell, displays extremely poor cycling stability and leads to early battery failure. It is obvious that attaining high performance and cycling stability is an insurmountable challenge at lean electrolyte conditions. For Li—S batteries based on solid-liquid conversion, relatively few publications explore methods to minimize E/S ratios. One practice is to alter the cathode structural design to minimize electrolyte requirements such as utilizing foam substrates, reducing the pore volume of the carbon and reducing porosity of the cathode. However, each one presents a trade-off which impairs the actual energy density. What has been neglected is to study the role an advanced separator has in attaining lean electrolyte conditions.

Polyolefin separators such as Celgard (TM Celgard, Inc.) with a thickness <25 μm and micron-sized pores are most commonly employed in LIBs; but by themselves, cannot perform vital functions required for a Li—S battery. Discourse on the role of the separator in Li—S batteries has emphasized on functionalities aimed at suppressing LiPS shuttling. Mass transport considerations, ionic conductivity and the ability to act as a separator/anode interface modulator to minimize metallic anode degradation are equally as important as is their role in attaining competitive energy density. The current state of affairs in separator research has focused on interlayers—an inserted freestanding film between the existing separator and electrode such as carbon cloth and graphene/CNT films. However, their added mass and volume, as well as unreasonably high electrolyte requirements can severely affect energy density. The ability to apply thin coatings or modifications on Celgard is a promising route for a high energy density battery, therefore a rational design for an advanced Li—S separator is to take the merits of the well-established Celgard as a platform for coatings and modification. Examples of reported materials for coating polyolefins include porous carbons, MWCNTs, graphene, graphene oxide; polymers such as Nafion or a Polymer of Intrinsic Nanoporosity (PIN), as well as materials such as metal oxides, Metal Organic Frameworks (MOFs), MXenes and metal disulfides such as MoS₂. Each of these materials have distinguishing qualities to further Li—S battery's performance, either by acting as a permselective membrane to reject UPS and allow Li+ ions to permeate, or by interacting/binding with LiPS. Graphene oxide and Nafion are examples of permselective materials, while for instance, porous carbons have high surface areas to physically ‘trap’ polysulfides and act as an upper current collector. Metal oxides, metal disulfides and MXenes have unique binding mechanisms and can act as electrocatalysts towards LiPS, while polymers partake in polar-polar interactions. The prevailing aim of these studies has been on imparting functionalities to suppress LiPS shuttle—and much less on the other consideration mentioned previously. Hence, designing an advanced separator is an ongoing challenge that must be tackled.

The object of this invention is to provide a membrane separator for a Lithium Sulfur battery that maximises areal capacity at lean electrolyte conditions to alleviate the above problems, or at least provide the public with a useful alternative.

### SUMMARY OF THE INVENTION

In a first aspect the invention provides a membrane separator for a Lithium-Sulfur battery comprising a porous polyolefin membrane coated with polyelectrolyte complex nanoparticles.

Polyelectrolyte complex nanoparticles for use in the membrane separator can be made by the steps of: a) making a solution of polyethylenimine (PEI) and tannic acid (TA); and b) adding bovine serum albumin (BSA) to the solution.

Preferably in forming the polyelectrolyte complex nanoparticles molar ratios of TA acidic sites plus BSA acidic sites to PEI amine functional groups plus BSA amine functional groups give a charge mixing ratio of approximately 1.5, and preferably the solution is maintained at a pH of approximately 6 and stirred to allow for complexation.

In preference the membrane separator is made by the steps of a) forming polyelectrolyte complex nanoparticles as described; b) purifying the nanoparticles; c) dispersing the nanoparticles to form a nanoparticle suspension; and d) dipcoating the porous polyolefin membrane in the nanoparticle suspension.

The membrane is preferably coated with a thin layer of carbon, which is preferably approximately 5 μm thick.

The invention also provides for a battery comprising the membrane.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 shows the steps involved in the formation of the polyelectrolyte complex nanoparticles and the deposition of Celgard with accompanying SEM images of Celgard and the PPX separator of the invention.

### DETAILED DESCRIPTION OF THE INVENTION

The present invention introduces the self-assembly chemistry of polyelectrolyte complexation and the unique ability to select and engineer its macromolecular constituents, allowing for targeted design of its functionalities and morphology to enable the design of an advanced separator. The tuned chemistry of the nanoparticles, its porous nature and high density of functional groups yields an exceptionally high LiPS adsorption capacity to address the shuttling phenomenon, and furthermore endows the separator with properties that are largely overlooked, but critical, such as high ionic conductivity, ability to control and improve mass transport properties and act as an anode/separator interface modulator. By introducing a key number of functionalities, the polyelectrolyte complex (PPX) nanoparticle membrane of the invention enables a high-performing Li—S battery with improved capacity, Coulombic efficiency, cycle life and due to the thin and efficient coating, allows for a “lean electrolyte” condition to be attained to give a competitive energy density.

The invention's unique porous polyelectrolyte complex nanoparticle, composed of tannic acid, polyethylenimine and bovine serum albumin protein, which thanks to its amphiphilicity, is able to form an even, submicron coating on the low-surface energy Celgard separator. The routinely used separator, Celgard (a polyolefin) is dip-coated into a bath of nanoparticles. The nanoparticles display an unprecedented polysulfide adsorption capacity of 482 mg_{LiPS} g⁻¹_{PPX}, enhance the ionic conductivity of the separator and significantly reduce internal cell resistances, enabling a cell with an initial discharge capacity of 1348 mAh g⁻¹ (5.12 mAh cm⁻²) with excellent rate capability and high cycling stability, all while maintaining a low electrolyte to sulfur ratio of 4.5 μL mg⁻¹. The high capacity of the coin cell was also successfully translated to a proof of concept pouch cell prototype with an initial capacity of 1212 mAh g⁻¹, paving the way for a separator suitable for the Li—S battery of the future.

The invention provides several beneficial functions to a cell, including: high ionic conductivity and improvement in lithium ion transference number, enabling efficient ion transport and significant reduction in internal cell resistances in the cell; exceptionally high adsorption capacity towards the intermediate polysulfide species, which effectively mitigates the “shuttling phenomenon”, an issue that plagues Li—S battery performance; and by acting as an ‘ion-redistributor’ at the anode/separator interface, the lithium-metal anode degradation is significantly reduced. Further benefits of the nanoparticles used includes being environmentally benign and safe, and simple processing and synthesis.

The polyelectrolyte complex is formed as the result of Coulombic interactions between the microdomains of oppositely charged polyionic components. The self-assembly of the nanoparticles is understood to be an entropy-driven process, where the release of low molecular weight counterions previously associated with the charged groups results in a gain in the entropy.

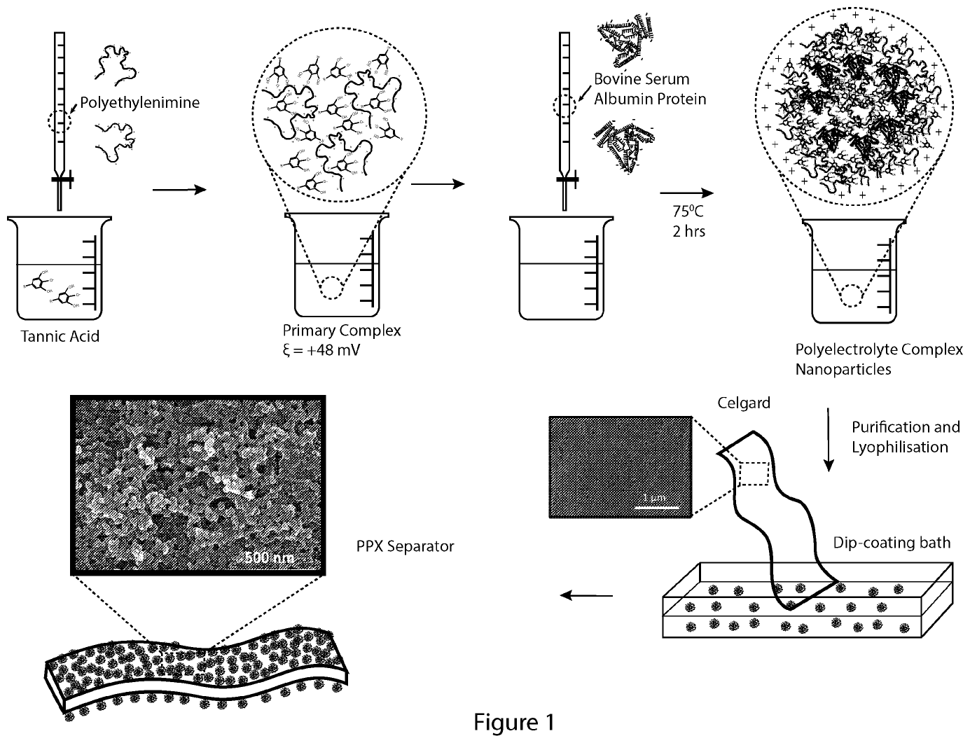

The polyelectrolyte complex nanoparticles are comprised of tannic acid (TA), polyethylenimine (PEI) and bovine serum albumin (BSA), and the underlying self-assembly mechanism of nanoparticle formation is presented in FIG. 1. Primary complexation occurs by the addition of PEI to TA by virtue of electrostatic interaction between the negatively charged TA and positively charged PEI. A 1:1 charge ratio core is typically formed during complexation, while the excess polyelectrolyte (PEI) forms a positively charged corona around this core and stabilizes the particles through electrostatic interactions, with a measured zeta potential of ξ=+48 mV. BSA is then added which thanks to heat and un-complexed TA molecules is able to denature and open up its structure, forming a secondary, negatively charged corona around this primary complex. Simultaneously, un-complexed TA and PEI form a tertiary corona, which results in an overall positively charged nanoparticles at ξ=+41 mV. Following purification and freeze-drying, the nanoparticles are re-dispersed in water and the Celgard separator is dip-coated to realize a thin coating.

As an example, a CR2032 coin cell incorporating the polyelectrolyte complex nanoparticle membrane of the invention can be made as follows.

Polyelectrolyte complex nanoparticles are first formed in non-stoichiometric conditions at predetermined charge mixing ratios, where R=n⁺/n⁻. A 10 mg/mL solution of TA is stirred at 1000 rpm. In the meantime, a 0.7 mg/mL PEI solution is added stepwise to the TA solution at a rate of 5 mL/min followed by the addition of 0.7 mg/mL BSA solution and is added stepwise at 2 mL/min. The approximate molar ratios of TA acidic sites+acidic sites in BSA:amine functional groups in PEI+amine functional groups in BSA give an overall mixing ratio of ˜R=1.5. Varying the charge ratio is achieved by varying the amount of cation (PEI) added. The pH of the solution is maintained at pH 6 by addition of 0.01 M NaOH. The solution is heated to 75° C. and stirred at 1000 rpm for 2 hours to allow for complete complexation. The solution is centrifuged for 15 min at 3000 rpm and the supernatant, comprised of un-complexed/free molecules is separated. The following wash is performed with acetone, followed by 2 more water-washing steps, and the supernatant is discarded. The polyelectrolyte complex nanoparticles are lyophilised. The solid nanoparticles are re-dispersed in water and stirred at 1000 rpm for 30 mins at 40° C. to ensure a homogeneous dispersion.

The polyelectrolyte complex (PPX) nanoparticles are next deposited on a Celgard 2730 membrane. The membrane is lightly rinsed with ethanol to remove air trapped in the pores. It is the dip-coated in the PPX nanoparticle suspension overnight (12 hrs), after which the membrane is air dried, lightly washed with DI water and dried in a vacuum oven at 45° C. for 3 hrs.

Synthesis of a Li₂S₆ solution for the cell is followed from the method reported by Liao et al. Elemental sulfur and Li₂S powder is mixed in a solvent of DOL and DME solvent (DOL/DME=50/50 (v/v)) at 50° C. for 36 h under stirring in an Argon glove box and with a molar ratio of 8:5 (8Li₂S+5S₈→8Li₂S₆). The resultant solution is centrifuged at 5000 rpm for 10 min and any unreacted particles removed.

To assemble the cell 65 wt % sulfur, 25 wt % carbon black and 10 wt % CMC binder are made into a thick aqueous slurry and tape casted with a doctor blade onto Al-foil current collector. The cathode is air-dried for 2 hours and further dried into a vacuum oven at 50° C. overnight. They are cut into 1 cm² disks with sulfur loading of 3.8 mg/cm² and the higher loading cathode of 5 mg/cm². CR2032 coin cells were assembled in an Ar-filled glove box with O₂ and moisture <0.1 ppm using a Li metal anode, aforementioned cathode and either Celgard or our PPX separator. The electrolyte is prepared using DME:DOL (vol 1:1) with 0.9 M LiTSFI and 0.7 wt % LiNO₃ as salts.

Various tests have been performed on membranes produced according to the invention with promising results. Scanning Electron Microscope (SEM) images and Energy-Dispersive X-ray Spectroscopy (EDS) mapping analysis reveal the successful deposition of polyelectrolyte complex nanoparticles on the separator (PPX separator) compared to unmodified Celgard, and confirm their even spatial distribution. A cross-section SEM micrograph reveals a coating thickness of ˜800 nm.

An X-ray Photon Spectroscopy (XPS) survey spectrum shows that the polyelectrolyte complex nanoparticle powder and the PPX separator have identical spectra. FTIR spectroscopy has been used to further assess complex formation, showing that the PPX separator has peaks arising from the functional groups of the nanoparticles.

To demonstrate the importance of amphiphilicity for successful deposition on a low surface energy material such as Celgard, a polyelectrolyte complex nanoparticle was synthesized which only has hydrophilic functional groups, comprised of polydiallyldimethylammonium chloride (pDADMAC) and polystyrene sulfonic acid (PSS). Even after an extended period of dip-coating of up to 48 hrs, little to no deposition was evidenced through SEM images, and the water contact angle remained unchanged to that of unmodified Celgard.

The presence of the phenolic rings of TA and hydrophobic domains of the BSA protein, on the other hand, are able to form hydrophobic bonds with the polyolefin surface—offering effective adhesion to the separator. These amphiphilic and adhesive properties of the nanoparticle are vital to enable deposition, as without such interactions, as witnessed by the hydrophilic pDADMAC-PSS nanoparticles, it was not possible to adhere to the separator.

On the other hand, the presence of hydrophilic functional groups such as —NH2, —OH and OOH endowed the PPX separator with a high degree of hydrophilicity. While water contact angle for Celgard is as high as 115°, due to the high porosity and intrinsically hydrophobic nature of polyethylene (and polyolefins in general), the PPX separator has a contact angle of 44°, decreasing down to ˜9° after 300 s, indicating water is being absorbed by the nanoparticles. The electrolyte (DOL/DME) contact angle reveals an initial value of 42° for Celgard and 37° for PPX separator—the major difference being that the PPX separator absorbs the electrolyte to a higher capacity and more rapidly, decreasing the contact angle to 8° after 260 s.

This is further confirmed by an electrolyte uptake test, which increases from 95% for Celgard to 150% for the PPX separator, which in complement also improved the electrolyte retention. Poor wettability and retention is not only a hindrance in industrial pouch-filling and a quality-critical process step, but can also affect a separator's ionic conductivity and homogeneity of Li+ ion transport—and ultimately performance which will be discussed more in the proceeding sections.

Cycling Performance and Electrochemical Characterization

To illustrate how our PPX separator enables a high-performance and lean electrolyte Li—S battery, a comparison was made between the performance of identical cells with PPX and with Celgard. For a sulfur loading of 3.8 mg cm⁻² and at a rate of 0.2 C, the cycling data shows the cell with Celgard has an initial capacity of 900 mAh g⁻¹, Coulombic efficiencies that drop to <90% after only 45 cycles and displays a severely limited cycle life. Employing the PPX separator significantly improves performance with an initial specific and areal capacity of 1348 mAh g⁻¹ and 5.12 mAh cm², respectively, with Coulombic efficiencies >99% for the first 30 cycles and remaining >97% with a capacity of 909 mAh g⁻¹ after 200 cycles.

This was achieved while keeping a challenging lean E/S ratio of 4.5 μL mg⁻¹, which was made possible by the very low PPX thickness and loading (0.1 mg cm⁻²) and added functionality, which overall gave our cell a competitive energy density of 240 Wh kg⁻¹, even in a coin cell level. Additionally, the reported performance was realized with a minimal amount of LiNO₃ at 0.6 wt % as a co-salt in the electrolyte—placing the cells in the lower tier compared to concentrations generally used, as high concentrations can overinflate Li—S battery performance.

Moreover, due to the added functionalities, our PPX separator cell displays high capacity and stable cycling even in the absence of LiNO₃. Comparing the charge/discharge voltage profile of cells configured with Celgard and PPX, an upper plateau is associated with a reduction of S₈ to Li₂S₈ and is mainly governed by the access of the electrolyte through the cathode, and is then followed by reduction to Li₂S₆ then Li₂S₄. The viscosity of the UPS containing electrolyte reaches a maximum at the end of this region, resulting in an over-potential. At this point, a lower plateau begins, which is the main contributor to capacity (˜75%). This second voltage plateau is associated with the full reduction of these highly soluble LiPS to the insoluble, insulating Li₂S₂/Li₂S species and is governed by the ability of the system to retain LiPS on the cathode side.

Whilst the onset of the lower voltage plateau is relatively close for both cells for the first cycle (˜395 mAh g⁻¹ and ˜415 mAh g⁻¹, respectively), the length of the second plateau is almost half in size in the cell configured with Celgard, indicating considerable shuttling has occurred. This is also evident by the significant over-potential at the onset of the second plateau in this cell. The overpotential continually increases with cycle number and is likely to originate from the ever-increasing electrolyte viscosity caused by worsening shuttle effects and electrolyte consumption. In comparison, the greatly extended lower discharge plateau of the PPX separator is indicative of its superior ability to mitigate LiPS shuttling.

Furthermore, there is a notable decrease in polarization when employing the PPX separator compared to Celgard, as both the voltages of the upper and lower discharge plateau increase from 2.240 V to 2.300 V and from 2.02 V to 2.06 V, respectively. In the first cycle, the polarization for the Celgard cell is 286.1 mV and 160.4 mV for the PPX separator cell, and after 20 cycles it is 346.0 mV and 216.7 mV, respectively.

After 50 cycles, the cell with Celgard, close to the end of its life, displays a rapidly decreasing capacity and Coulombic efficiency that drops <90%, with polarization increasing up to 398.4 mV, whereas after the 58^{th} cycle, no second plateau is formed at all, indicative of extreme polarization, severe shuttling, anode damage and drying up of the cell.

The combined effects of shuttle suppression, higher ionic conductivity, lower internal resistances and preservation of the anode (discussed in more detail below) are responsible for a much lower polarization for the PPX separator and are also conducive to dramatically improved rate capability. Rate capability tests were carried out at various C-rates from 0.1 C to 1 C. At a rate of 1 C, the PPX separator maintains a capacity of 781 mAh g⁻¹ and displays efficiencies >98.5%, while Celgard displays a capacity of only 340 mAh g⁻¹ with efficiencies <90%. When the C-rate is switched back to 0.25 C and 0.1 C, PPX recovers remarkably well with only small capacity differences (˜5% and ˜3%, respectively). This is in contrast to Celgard, which shows rapid capacity decay and very low efficiencies (<80%) at 1 C, and thereafter (and similarly to the long-term cycling data), starts to show signs of failure with rapid decrease in capacity.

The PPX separator can also be advantageously coated with a thin layer of carbon (5 μm, 0.8 mg cm⁻²) which acts as an upper current collector, allowing thicker and higher loading cathodes at 5.5 mg cm⁻² to give a high initial areal capacity of 7.4 mAh cm⁻² and remaining at 5.8 mAh cm⁻² after 120 cycles, with efficiencies >99%. The thin nanoparticle and carbon coating allowed for lean E/S ratio to be maintained (5 μL mg⁻¹), yielding a specific energy density of 270 Wh kg⁻¹ in a coin cell (FIG. 3d).

To display the scalability potential and verify its robustness, large sheets of the PPX separator were prepared and pouch cell prototypes fabricated (4 layers, 2.5×6 cm) at a sulfur loading of 3.8 mg cm⁻². Specific capacities were achieved that are essentially similar to those obtained for corresponding coin cells at 1218 mAh g⁻¹, indicating successful scale-up and translation from coin cell to pouch cell. Owing to the low weight proportion of the separator in the pouch cell of only 5.5 wt % and lean E/S ratio of 4.6 μL mg⁻¹ an initial energy density of 250 Wh kg⁻¹ was recorded based on the mass of the anode, cathode, current collector, separator and electrolyte. With more optimized pouch cell manufacturing methods and double-sided cathodes, it is believed that energy density can be further enhanced.

To further exhibit its suitability for practical applications, it has been demonstrated that the PPX separator imparts additional functionalities to a cell such as improving self-discharge, which maintained a voltage of 2.62 V even after 40 days, compared to 2.38 V for Celgard. In addition, the nanoparticle coating imparts improved thermal and mechanical safety as determined by a thermal shrinkage and tensile test, respectively.

To gain insight into the mass transport properties of the separator, the ionic conductivity (σ) was measured by an AC impedance technique and was found to increase from 1.05×10⁻⁴ S cm⁻¹ for Celgard to 2.05×10⁻⁴ S cm⁻¹ for the PPX separator. It is believed that the Coulombic interactions between the nanoparticles and the ions in the electrolyte weaken the electrostatic ion-ion interactions between cations and anions to increase the degree of ion pair dissociation (i.e. weakening the solvation effect of Li⁺), and lead to an enhancement in ion transport and conductivity. By varying the charge ratios, R, we found that the ionic conductivity at values of R>1 are similar, however at R<1, the ionic conductivity was found to be ˜25% lower. While across all R values the ionic conductivity was improved compared to Celgard, the enhanced a at R>1 suggests that the positively charged and lithiophilic amine groups of the nanoparticles are responsible for the improved ionic conductivity.

In addition, the secondary structure of the nanoparticles allows for a loose coating architecture with a predominance of voids which increases the presence of transport channels and decreases mass transfer resistance. Since diffusion time (τ_{d}) has a quadratic dependence on the diffusion length (L), τ_{d}˜L², shortening the diffusion path by morphological effects is expected to realize better kinetics and minimize charge transfer resistance in a cell. For comparison, this was found to be true for a polyelectrolyte complex nanoparticle coating on a nanofiltration membrane, helping to accelerate molecular diffusion, decrease mass transfer resistance and increase permeance flux.

This is in contrast to the more prevalent layer-by-layer (LbL) deposition of polyelectrolyte films—since they are not porous and do have the morphology of a nanoparticle, they add to mass transfer resistance. To demonstrate this further, LbL deposition was carried out on Celgard, and resulted in an evident reduction in porosity, which is reflected by the lower ionic conductivity a. In addition, a higher electrolyte uptake, which is the case for PPX at 150% compared to only 95% for Celgard, is also correlated with the separator's increase in ionic conductivity, because of its higher affinity and therefore retention of electrolyte, compared to Celgard, whose poor affinity leads to electrolyte leakage during cycling and therefore poorer ionic conductivity.

Another important mass transport consideration in a cell is the Li⁺ transference number (t_{Li}⁺), which is the fraction of total ionic current carried by Li⁺ ions. Improving the t_{Li}⁺ value is an active area of research in LIBs but underappreciated in Li—S literature. It significantly reduces the concentration gradient in a cell, improving rating capability and overall performance. Calculation of t_{Li}⁺ using a DC polarization technique, found an increase from 0.71 for Celgard to 0.75 for the PPX separator. It is believed the lithiophilic nature of the amine and amino groups from PEI and BSA, in addition to increased interaction with anions reduces anion mobility while increasing Li⁺ mobility.

To further investigate the influence of the polyelectrolyte complex coating on facilitating ion transport and reducing cell resistances, Electrochemical Impedance Spectroscopy (EIS) was carried out at fully charged states for fresh cells, after 1 cycle and 40 cycles. Nyquist plots obtained are composed of a semi-circle in the high frequency region, whose diameter is interpreted as the charge transfer resistance (Ret) and an inclined line in the low frequency domain which is a factor that dictates capacity fading and electrochemical response of a Li—S battery.

The R_{ct} of the cell with Celgard is 5-7 times higher and increases more rapidly with cycle number compared with the PPX separator. This can be explained by the feedback loop of low ionic conductivity and electrolyte leakage, excessive LiPS shuttling and precipitation of the insulating Li₂S₂/Li₂S species on the separator and anode surfaces, ultimately blocking transport pathways. In addition to these effects, another reason for the dramatically higher R_{ct} of Celgard is that the anode in such a cell also suffers from more pronounced degradation, which leads to increasing electrolyte consumption. The side effects such as increasing electrolyte viscosity are felt more strongly in a cell with lean electrolyte conditions with which we are operating and significantly contributes to the increase of R_{ct} by a factor of ˜3 for Celgard that was observed.

Polyelectrolyte Complex Nanoparticles as an Efficient LiPS Adsorbent

It is well-accepted that a separator coating should regulate LiPS shuttle—so a more systematic characterization of the adsorption capacity of the nanoparticles and the role they play in mitigating UPS shuttling was performed. A batch adsorption experiment was carried out between the nanoparticles and a model LiPS—Li₂S₆.

A Langmuir model was found to best describe the isotherm, which suggests monolayer sorption. The model reveals an equilibrium capacity of 482 mg_{LiPS} g⁻¹_{PPX}, a Langmuir constant K_{L}=1.08 L mg⁻¹ and a model fit of R²=0.992. The equilibrium capacity of the polyelectrolyte complex nanoparticles is significantly larger than for instance, an advanced adsorbent MNCS/CNT material (177 mg_{LiPS} g^{-1 55}), by a factor of 3. Another essential feature of this model can be expressed as a dimensionless constant called the separation factor R_{L}, which indicates unfavorable (R_{L}>1) or favorable (0<R_{L}<1) adsorption. Our isotherm yields R_{L}=0.19, whose low values in addition to a negative calculated adsorption free energy (ΔG⁰=−22.12 kJ mol⁻¹) indicates a favorable and spontaneous process.

To further draw a comparison with other commonly employed LiPS adsorbents in literature, a comparative study was carried out with carbon black, a metal oxide (TiO₂) and a metal disulfide (MoS₂). Under identical driving forces, carbon black had the lowest capacity at 38 mg_{LiPS} g⁻¹, TiO₂ and MoS₂ had 78 and 110 mg_{LiPS} g⁻¹, respectively, while our nanoparticles had an impressive capacity of 395 mg_{LiPS} g⁻¹_{PPX}. Despite the fact that both metal oxides and metal disulfides have high calculated binding energies with UPS, this comparative study demonstrates that high binding energies do not necessarily translate to high adsorption capacities towards LiPS. While a study found high capacities per unit surface area for these materials, they are ultimately limited by their low accessible surface areas (<10-20 m² g⁻¹). This cements that the engineered nanoparticles are able to function as an efficient LiPS modulator at the cathode/separator interface, an indispensable role in improving Li—S battery performance.

This exceptional adsorption capacity is attributed to the high surface area of the nanoparticles, (˜120 m² g⁻¹ by BET analysis and pore size in the range of 1.5-2 nm, and a vast number of sites available for binding interactions in this engineered nanoparticle system. The nature of interactions between LiPS and the nanoparticles is through polar-polar interactions arising from the uniquely large number and a variety of functional groups that make up the nanoparticles.

Monolayer sorption, as revealed by the Langmuir model, suggests each functional group interacts with one molecule of LiPS. The FTIR spectra of the PPX separator before and after adsorption is compared to give an insight into possible adsorption mechanisms. These polar-polar interactions are more likely to occur through physisorption, however there is evident that some chemisorption may be occurring concurrently. There is a reduction in intensity and considerable shifts in the peaks associated with C═O at 1659 cm⁻¹ and 1702 cm⁻¹ (by ˜25 cm⁻¹), typically indicative of chemisorption. This is in line with a study that found LiPS can attack the nucleophilic C═O bond to form an S—O bond, which can be confirmed by the formation of new S—O peaks at 1062 cm⁻¹.

The peak shifts and reduction in intensity can also be explained by the interaction between C═O and Li⁺ atoms of LiPS. Phenol peaks at 3000-3500 cm⁻¹, 1091 cm⁻¹ and 1037 cm⁻¹ on the other hand also experience a reduction in intensity, but a smaller shift in wavenumber (˜10 cm⁻¹). Despite studies showing that —OH groups can be cleaved to form a thiosulfate complex, in our case, it is most likely that physisorption is the dominant driving force for interaction. Other bands associated with nitrogen functional groups at 3000-3500 cm⁻¹, Amide II and Amide III bands also display a change in intensity and a shift in wavenumber (˜5 cm⁻¹), but more conducive to physisorption. This is arising from Li—N and S—N interactions between LiPS and amine groups.

Despite the large number of functional groups and mechanisms involved in the adsorption process, the calculated bulk adsorption free energy of ΔG⁰=−22.12 kJ mol⁻¹, which is slightly above the physisorption range (ΔG⁰>−20 kJ mol⁻¹), but well below chemisorption (ΔG⁰<−80 kJ mol⁻¹), suggests that while physisorption and chemisorption might be occurring concurrently (and corroborated by our FTIR results above), overall, physisorption is the more dominant mechanism.

Further evidence of the successful repression of LiPS shuttle is seen by the post-mortem SEM images of Li metal. It is apparent that employing the Celgard separator leads to severe powdering compared to the case of the PPX separator—a consequence of uncontrollable Li dendrite growth, which continually consumes liquid electrolyte and is more pronounced at low E/S ratios, causing increased polarization, low Coulombic efficiencies and rapid capacity loss, as has been demonstrated to be the case for the Celgard separator. The way in which Li anode degradation is minimized by employing the PPX separator is twofold. The double-sided coating improves the wettability (increased electrolyte uptake) and can act as an ‘ion-redistributor’, both of which promote a more homogenous Li⁺ flux to achieve more stable Li electrodeposition (and therefore minimize dendrites), as has been the case for a number of hydrophilic separator coatings. This is demonstrated by our Li|Li symmetric cells. In addition, the the essential function of repressing UPS shuttle, which prevents the parasitic reactions between LiPS and the Li metal surface and the deposition of insulating Li₂S that accelerate powdering and cell failure.

A comparative analysis of notable analogous studies is testament that achieving the trade-off of low thickness, lean electrolyte conditions and high areal capacity is still a challenge in literature. It is reasonable to conclude that our nanoparticle coating outperforms the current state of separator literature with regards to these metrics. Our polyelectrolyte complex nanoparticle coating seemingly enables our cells to address this trade-off by reaching high areal capacities at low loading and thickness of the coating, while retaining lean electrolyte conditions.

The above disclosure describes a method to co-assemble macromolecules into porous nanoparticles to give unique control over its properties and architectures. With its amphiphilicity, specially tailored pore size and large number of polar functional groups, the polyelectrolyte complex nanoparticles formed a uniform, submicron-thick coating on Celgard and endowed the separator with multi-functionality. The high degree of tuneability of polyelectrolyte complex nano-structures allows maximizing Li+ ion and LiPS selectivity, enhancing mass transport properties between the electrodes and mitigating Li metal pulverization. By maintaining coating thickness and loading low, the challenging trade-off in separator design of minimizing coating thickness/loading and E/S ratios while maximizing areal capacity is achieved. Competitive areal capacities at lean electrolyte conditions are attained. With application of the already commercialized Celgard separator, the tremendous cost-effectiveness of nanoparticle synthesis, their environmentally benign nature, and ability to design and engineer targeted functionalities, this class of materials has a strong potential to enable high volumetric and energy density Li—S batteries.

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A membrane separator for a Lithium-Sulfur battery comprising a porous polyolefin membrane coated with polyelectrolyte complex nanoparticles.

2. A method of forming polyelectrolyte complex nanoparticles for use in a membrane separator, said method comprising the steps of:
a) making a solution of polyethylenimine (PEI) and tannic acid (TA); and
b) adding bovine serum albumin (BSA) to the solution.

3. The method of forming polyelectrolyte complex nanoparticles as in claim 2, wherein the molar ratios of TA acidic sites plus BSA acidic sites to PEI amine functional groups plus BSA amine functional groups give a charge mixing ratio of approximately 1.5.

4. The method as in claim 2, wherein the solution is maintained at a pH of approximately 6 and stirred to allow for complexation.

5. A method of making a membrane separator for a Lithium-Sulfur battery, said method comprising the steps of:
a) forming polyelectrolyte complex nanoparticles by making a solution of polyethylenimine (PEI) and tannic acid (TA); and adding bovine serum albumin (BSA) to the solution;
b) purifying the nanoparticles;
c) dispersing the nanoparticles to form a nanoparticle suspension; and
d) dipcoating a porous polyolefin membrane in the nanoparticle suspension.

6. The method of making a membrane as in claim 5, further comprising the step of coating the porous polyolefin membrane with a thin layer of carbon.

7. The method as in claim 5, wherein the layer of carbon is approximately 5 μm thick.

8. A battery comprising a membrane separator as in claim 1.

9. The method as in claim 2, wherein the membrane separator is a porous polyolefin membrane and the method further comprises coating the porous polyolefin membrane with the polyelectrolyte complex nanoparticles.
